(19) United States
(12) Patent Application Publication
(10) Pub. No.: US 2021/0357953 A1
(43) Pub. Date: Nov. 18, 2021

(54) AVAILABILITY RANKING SYSTEM AND METHOD

(71) Applicant: OPTIMALQ TECHNOLOGIES LTD., Tel Aviv (IL)

(72) Inventors: Yechiel LEVI, Petah Tikva (IL); Yadin Henry HAUT, Tel Aviv (IL)

(21) Appl. No.: 16/965,985

(22) PCT Filed: Jul. 5, 2019
(86) PCT No.: PCT/IB2019/055759

§ 371 Date: Jul. 29, 2020

Related U.S. Application Data
(60) Provisional application No. 62/694,043, filed on Jul. 5, 2018.

(51) Int. Cl. G06Q 30/02

(52) U.S. Cl. CPC G06Q 30/0201; G06Q 30/0275

(57) ABSTRACT

A method of optimizing a customer engagement includes communicating with a plurality of data providers to acquire information associated with a customer's computer-trackable use of one or more computing devices. The method additionally includes, for each customer, acquiring data associated with availability events in the information, processing the acquired data including applying a weighting factor during the processing, and calculating a weighted availability score for the customer. The method further includes generating an availability list including the weighted availability score of each customer, combining a weighted business logic score for each customer with the customer weighted availability score in the availability list, generating a ranking list wherein a plurality of customers are ranked by the combined business logic score and weighted availability score of each customer, transferring the ranking list to a customer engagement system for engaging with each customer according to their ranking order on the ranking list, and acquiring from the customer engagement system engagement data associated with the engaging for each customer in the plurality of customers.

### CROSS-REFERENCE TO RELATED APPLICATIONS

This application claims benefit from U.S. Provisional Patent Application No. 62/694,043, filed 5 Jul. 2018, which is hereby incorporated in its entirety by reference.

### FIELD OF THE INVENTION

The present invention, in some embodiments thereof, relates to customer engagement and connection systems and methods for, and more particularly, but not exclusively, to a system and method for determining the contact availability of current and potential customers.

### BACKGROUND OF THE INVENTION

Many organizations analyze data associated with customers' history with a company to improve business relationships with customers, specifically focusing on customer retention and ultimately driving sales growth. One important aspect involves the compilation of data from a range of different communication channels, including a company's website, telephone, email, live chat, marketing materials, and more recently, and social media. This allows businesses to learn more about their target audiences and may learn how to best cater to their needs.

Many companies and organizations frequently attempt to contact a customer to offer their products without regard to the time and attention that the customer can devote to a conversation with a sales and/or service representative (hereinafter “sales rep”). Some studies show that correct timing of actions vis-à-vis the customer may significantly increase the quality of the service received by the customer and the client's receptiveness to receive sales and other engagement offers.

As an example, the telephone sales process is typically the same for many companies and organizations and frequently depends on a list of contacts. This list of contacts is generally created relying on lead collection from multiple sources such as, for example, Google Adwords, TV, Affiliations, among other potential sources; on lead prioritization according to relevancy, for example, an insurance company contacting all customers who need to renew their insurance policy next month; as well as, in some circumstances, may rely on self-initiative.

A drawback associated with the telephone sales process is the total disregard by the sales rep of the availability of the customer to accept and manage a sales call. As a result, many conversations remain unanswered, or if the call is answered, only a limited period of time is budgeted by the customer to handle the call during which time the customer may be neither physically and mentally attentive. Consequently, the customer's unavailability to handle the call is reflected in a low conversion ratio and in loss of income to the organization.

Notwithstanding the problem of the unavailability of customers, the competition to secure customers is huge. A customer who leaves details on a Web site (e.g. Wobi) may find that the details are distributed to multiple organizations. Organizations frequently lose about 35%-50% of their potential customers because they fail to contact them before their sales offer becomes irrelevant to them (https://blog.hubspot.com/sales/sales-statistics).

Most companies attempt to dial the customer up to 3 times. The response rate generally ranges from 15-30% and therefore, the following calculation may be applied (i.e. 1−0.3=total missed calls):

0.7*0.7*0.7==34.3% Percentage of leads that were unable to reach them.

Systems and methods which attempt to solve the problem of customer unavailability are known in the art. For example, Ristock et al. in US Patent Application Publication US 2014/0126713 A1 discloses “A system and method for establishing contact between a customer contact center agent and a customer based on customer availability information. A plurality of communication channels that may be used to communicate with the customer is monitored by the contact center. The availability of the customer is identified for each of the plurality of communication channels and user availability data is dynamically adjusted for each of the plurality of communication channels. The user availability data is provided to a contact center agent handling, for example, an offline task involving the customer. The contact center agent may use the availability data to establish contact with the customer to better handle the offline task”.

### SUMMARY OF THE PRESENT INVENTION

There is provided, in accordance with an embodiment of the present invention, a method of optimizing a customer engagement includes communicating with a plurality of data providers to acquire information associated with a customer's computer-trackable use of one or more computing devices. The method additionally includes, for each customer, acquiring data associated with availability events in the information, processing the acquired data including applying a weighting factor during the processing, and calculating a weighted availability score for the customer. The method further includes generating an availability list including the weighted availability score of each customer, combining a weighted business logic score for each customer with the customer weighted availability score in the availability list, generating a ranking list wherein a plurality of customers are ranked by the combined business logic score and weighted availability score of each customer, transferring the ranking list to a customer engagement system for engaging with each customer according to their ranking order on the ranking list, and acquiring from the customer engagement system engagement data associated with the engaging for each customer in the plurality of customers. Optionally, the processing may include generating availability event structures. Optionally, the availability events include duration of availability.

In some embodiments, the method additionally includes adjusting the weighted business logic score for at least a portion of the customers based on the engagement data, and adjusting the weighting factor applied during the processing. The method may additionally include sending the engagement data to the plurality of data providers.

In some embodiments, the method additionally includes generating an availability score from the availability event structure. Optionally, the acquired data includes an availability score.

In some embodiments, the method additionally includes acquiring the information from external availability vendors. Optionally, the external availability vendors include a social network.

In some embodiments, the method additionally includes acquiring the information through an exchange network. Optionally, the network is cloud-based.

In some embodiments, the method additionally includes acquiring the information from a real-time bidding (RTB) network. The method further includes extracting availability information from the RTB network information by performing any combination of the following tasks: combining a plurality of events; filtering the plurality of events into availability significant and insignificant events; identifying the customer's activity time; and analyzing whether each event is superficial and immediate or an in-depth event. Optionally, the RTB network information is based on website domains and/or content and/or categories.

In some embodiments, the method additionally includes creating a time-based availability structure based on the plurality of events. Optionally, the method includes tagging events based on a predefined activity type.

In some embodiments, the method additionally includes using clustering to group customers with similar network behavior. Optionally, the method includes using metrics to identify a level of referrals the customer had at the time of the connection. Optionally, the method includes creating a historical profile for the customer.

In some embodiments, the method additionally includes identifying a customer using means other than the customer's name. Optionally, the method includes sending customer availability data to availability buyers through an exchange network.

There is provided, in accordance with an embodiment of the present invention, a system for optimizing a customer engagement including a database, communication means to communicate with a plurality of data providers to acquire information associated with a customer's computer-trackable use of one or more computing devices, and a processor configured to, for each customer, acquire data associated with availability events in the information, process the acquired data including applying a weighting factor during the processing, and calculate a weighted availability score for the customer. The processor is additionally configured to generate an availability list including the weighted availability score of each customer, combine a weighted business logic score for each customer with the customer weighted availability score in the availability list and generate a ranking list wherein the plurality of customers are ranked by the combined business logic score and weighted availability score of each customer. The processor is also configured to transfer the ranking list to a customer engagement system for engaging with each customer according to their ranking order on the ranking list, and to acquire from the customer engagement system engagement data associated with the engaging for each customer in the plurality of customers. Optionally, the availability events include duration of availability.

In some embodiments, the processor is further configured to adjust the weighted business logic score for at least a portion of the customers based on the engagement data, and to adjust the weighting factor applied during the processing.

In some embodiments, the processor is further configured to send the engagement data to the plurality of data providers. Optionally, the processing includes generating availability event structures. Optionally, the processor generates an availability score from the availability event structure. Optionally, the acquired data includes an availability score.

In some embodiments, the communication means acquires the information from external availability vendors. Optionally, the external availability vendors include a social network.

In some embodiments, the system includes an exchange network. Optionally, the network is cloud-based.

In some embodiments, the communication means acquires the information from a real-time bidding (RTB) network. Optionally, the processor acquires availability information from the RTB network information by performing any combination of the following tasks: combining a plurality of events; filtering the plurality of events into availability significant and insignificant events; identifying the customer's activity time; and analyzing whether each event is superficial and immediate, or an in-depth event. Optionally, the RTB network information is based on website domains and/or content and/or categories.

In some embodiments, the processor creates a time-based availability structure based on the plurality of events. Optionally, the processor tags events based on a predefined activity type.

In some embodiments, the processor uses clustering to group customers with similar network behavior. Optionally, the processor uses metrics to identify a level of referrals the customer had at the time of the connection. Optionally, the processor creates a historical profile for the customer.

In some embodiments, the processor identifies a customer using means other than the customer's name. Optionally, the processor sends customer availability data to availability buyers through an exchange network.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 schematically illustrates an exemplary availability ranking system, according to an embodiment of the present invention;

FIG. 2 schematically illustrates an exemplary availability ranking system configured to generate optimal queueing information from availability information received from data collection and data exchange networks for sale to availability buyers, according to an embodiment of the present invention;

FIG. 3 schematically illustrates an exemplary availability ranking system configured to generate optimal queueing information from availability information received from availability sellers for sale to availability buyers, according to an embodiment of the present invention;

FIG. 4 schematically illustrates an exemplary availability ranking system configured to generate optimal queueing information from availability information received from organizations for sale to availability buyers, according to an embodiment of the present invention;

FIGS. 5A, 5B and 5C are a flow chart of an exemplary method of using the availability ranking system in a customer engagement, according to an embodiment of the present invention;

FIG. 6 is a flow chart of a method of how the availability engine may analyze availability responsive to receiving an availability event, according to an embodiment of the present invention;

FIG. 7 is a flow chart of a method of how an Availability Engine may analyze availability responsive to receiving a request for the merged availability list from an Engagement Optimization Platform or from an external Availability Provider, according to an embodiment of the present invention;

FIG. 8 is a flow chart of a method of how customers may be synched in a ranking system, according to an embodiment of the present invention; and

FIG. 9 is a flow chart of a method of how data from data sources is received in the ranking system, according to an embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicants have realized that the first to reach the customer when he or she is physically and mentally available will have the highest conversion rates. Applicants have further realized that more and more people are doing more and more operations with smartphones and that most of the operations are translated into Internet activity, and that consequently, the smart phone and the services consumed on the Internet may attest to the physical and mental condition of a customer. Applicants have further realized that product and service vendors may maximize their profits by finding the balance between business logic (customers with highest probability of making the purchase) and availability logic (customers with the greatest availability), reaching more customers and identifying customers who are considered less profitable but communicating with them faster and better.

Accordingly, Applicants have devised an availability ranking system to identify customer availability and to analyze their respective communications media with reference to customer physical and mental availability. Such a system may enable a company to contact customers, using the respective communications media, when they are physically and mentally available, thereby improving conversion rates and quality of service.

Different organizations work in different ways, using different CRM systems, different automated dial-up systems, and different Web/Application analytics tools, among others. The availability ranking system of the present invention may provide a generic layer with expansion capabilities that can draw from different sources relevant information about customer availability as may apply to each specific organization. It may facilitate the process of data mining and data analysis, and may allow interfacing with the current sales process of each organization to maximize customer availability.

The availability ranking system of the present invention may provide for optimal scheduling for marketing by determining the best time to contact potential and existing customers. It may additionally determine a preferred communication channel to contact a customer according to time and availability (i.e. email, phone, SMS, Chat bot, etc.). It may evaluate and forecast customer availability which may be used to support recommendations on the organization required to support the business activity (the number of representatives required at each shift in a sales center). It may rank customers on the basis of the duration of the availability. It may provide a platform for sharing availability information without compromising user privacy. It may also allow organizations to sell availability information.

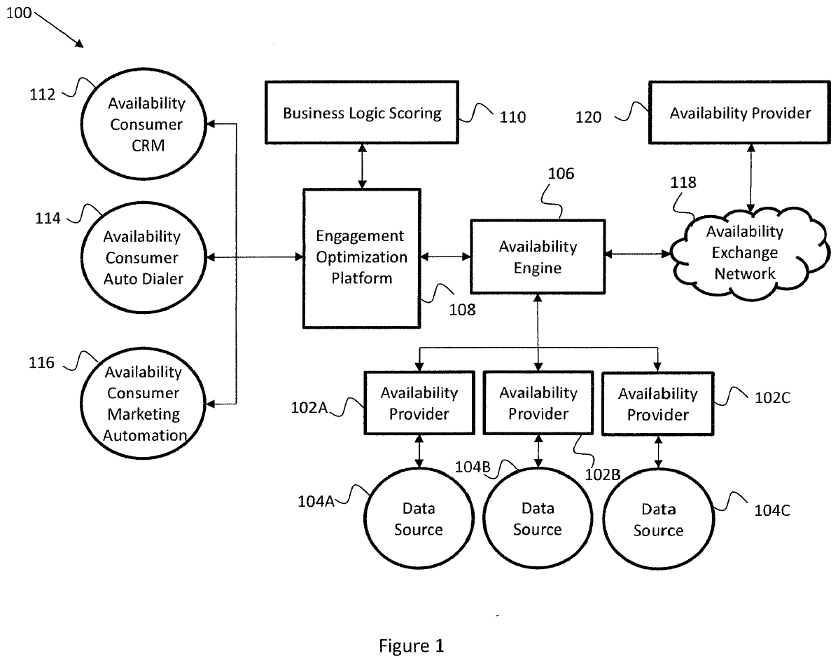

Shown in FIG. 1 schematically illustrates an exemplary availability ranking system 100, according to an embodiment of the present invention. The system may include availability providers (AP), for example AP 102A, 102B, 102C and external availability providers (EAP) 120, organizational data sources (DS), for example DS 104A-104C, an availability engine (AE) 106, an engagement optimization platform (EOP) 108, a business logic scoring module (BLS) 110, availability consumers (AC), for example AC 112, 114, and 116, and an availability exchange network (AEN) 118 which may be cloud based.

AP 102A-102C may control DS 104A-104C, respectively, and may collect relevant data from them. They may perform automatic identification of DS events structures in DS 104A-104C and may rank elements in the collected data which may affect customer availability. Ranking of the elements may be based on importance, automatically detecting best elements or features in the data structure that may be relevant for availability. Examples of elements may include call duration, IP address, and geographic location, among other relevant information.

AP 102A-102C may convert information from the respective DS into an “availability event” structure for fast retrieval and efficient storage, and for structured learning. The availability event may be a single data point that may include, for example, a timestamp, type of event, duration of event, among other parameters of the data point (some parameters may be relevant only to specific data sources). They may control the DS, for example, to control the rate of retrieval of data from the system, or to carry out specific operations such as querying specific customers, or to limit the amount of queries based on quota or price.

AP 102A-102C may each respectively receive data from DS 104A-104C, may filter them according to data relevance (for example, only data associated with customers of interest), process the data and send the processed data onwards in the system. The processed data may be in the form of raw data including the availability event structure which is processed by AE 106 to calculate a score for each customer. AP 102A-102C may perform actions such as generating a list of interesting customers, change the rate of operation and retrieval of information from DS 104A-104C, retrieve data for the customer list, among other tasks. It may query DS 104A-104C for “coverage”, that is, for example, to see if they have any data on the customer, to see how frequent there is customer data, and to see when was the last event, among other data. Optionally, one or more of AP 102A-102C may include an availability engine (AE) which may allow the AP to output the processed data to AE 106 as a score for the customer.

DS 104A-104C may include any sources of data from which streaming or query data may be obtained, generally organizational in nature, for example, phone call records, credit card transactions, mails, website visits, CRM data, among many other data sources. DS 104A-104C may each receive a series of commands from AP 102A-102C, respectively, which may include, for example, capturing data on a specific customer, including reporting on events, changing settings in the DS, among other control commands. DS 104A-104C may generate data which may include a stream of events, either real time or historical, which are used by AP 102A-104C to generate the raw data, or alternatively, if the AP has an AE, to generate scores for the customers.

EAP 120 may include some or all of the functions of AP 102-104 and may include an AE. EAP 120 may interface with AE 106 through AEN 118 and may provide processed data from external availability data vendors (availability vendors, AV) including a final score computed by the availability vendors for a customer. The availability vendors may include, for example, mobile phone companies, website pixel trackers, mail trackers, social networks, credit card companies, organizations, among others.

AE 106 may be a separate system module as shown in the figure, and may additionally or alternatively be implemented in one or more of the AP 102A-102C. It may combine the raw data received from AP 102A-102C to calculate a score for a customer, or alternatively may receive scores from the AP. It may additionally receive customer scores from EAP 120 and may combine it with that from AP 102A-A102C to generate a merged availability queue (merged availability list, MAL).

AE 106 may automatically assign weights to AP 102A-102C and EAP 120, based on a type of customer, so for example, an EAP such as CNN may receive priority over an EAP such as Orange Telecom, and vice versa. AE 106 may learn, from each engagement, how accurate is each AP and EAP and may dynamically update the weights of each per relevant customer or per relevant campaign. The results of the engagement may be sent to every AP and EAP that sent results and may allow each AP and EAP to increase the scoring for those customers based on a ranking accuracy. For example, if a DS was mistaken multiple times the weight assigned to the AP may be decreased, but if later the accuracy of the DS increases the weight of the AP may be increased.

Reinforcement learning may be used to enable the system to automatically lean to a better AP or EAP in order to achieve a better campaign. For example, every call campaign may have its leads. For every call, scores ranging from 0 to 1 may be received from a number of AP and EAP based on the result of the call (e.g. answer/no answer, call duration, business outcome). Responsively, AE 106 may automatically give more weight to the AP or EAP that was more “correct” with regards to the customer. Assuming that Orange Telecom gives a score of 0.2 to a customer as a ranking of the expected result of a call, and CNN gives a score of 0.8 to the customer, during a campaign, if, for example, the customer answered the call, the ranking score for the customer may be expressed by:

CNN_WEIGHT*CNN_SCORE+ORANGE_WEIGHT*ORANGE_SCORE;

with the value of CNN_WEIGHT increasing and ORANGE_WEIGHT decreasing as CNN predicted a higher probability that the customer would answer the call, thereby rewarding the AP or EAP which provided a higher ranking for the customer.

AE 106 may distribute the information obtained from a variety of sources into a sequence of events and may analyze the events to generate available insights. The insight may be a pattern in the data or a feature that was extracted from the data which the AE may determine to be relevant to the type of engagement. AE 106 may generate the insights from raw data, may score them and may rank customers by availability. The insights may serve to infer from the network behavior of different DS whether the customer is available or not. The ranking may be performed by individual scoring of leads.

AE 106 may build models based on organizational information and may enable manipulation of existing information in order to build new models and experiment with them in the system. It may run tests using machine learning and AI algorithms such as, for example, linear regression, hidden Markov, and Random Forest, among others, and may identify, based on existing data, which model and algorithm work best. It may run machine learning models and deep learning models on time sequences (e.g. hidden Markov, convolutional neural network—cnn) or random forest, for example, to predict more accurately customer availability.

AE 106 may connect to availability vendors through AEN 118 and external EAP 120. For example, CNN may obtain from EAP 120, through AEN 118, and optionally from AE 106, availability information from Orange Telecom to determine availability of its customers from their cellular behavior. It may allow exchanging lists of customers with whom information is desired, and may allow updating EAP 120 with new settings and more. AE 106 may include a mechanism for receiving information from EAP 120, including availability information, optionally as scores for the customers, for the availability analysis. It may assign different resources to EAP 120, for example, to allocate $100 a month to buy availability information from EAP CNN and $500 from EAP Facebook.

AE 106 may perform availability analyses and may provide availability ranking recommendations to organizations. The ranking recommendations may be issued in the form of a ranking list (RL). It may connect, manage, and receive information from intra-organizational availability providers on a regular basis for customers that the organization may be currently interested in. It may acquire information available from the systems data collection and sharing network. This information may come in one of two forms, raw information of availability events and processed information (sorted queues of customers based on availability scores).

AE 106 may identify patterns and sequences of activity and may connect them to availability events. It may then attempt to find similarities between different availability events. From similar sequences, it may produce an “activity profile” that may enable classifying a customer into a group based on the customer's network activity.

AE 106 may create a “profile” of a customer's activity in order to classify customers into similar customer types (clustering) and to learn about new customers' availability from availability information received from previous customers. It may predict future availability by identifying partial patterns and adapting them to previous availability patterns in combination with the customer profile. Predicting future availability may allow AE 106 to assess whether the customer will be more or less available in the near future.

AE 106 may identify and recommend the optimal connection channels for AC 112, 114, and 116 at any given time. For each type of connection with the customer, a system user may send a report to the system with record of the time of the call, the customer, whether the connection was successful, the duration of the call, and what communication means was used. It may analyze the calls and previous availability ratings and may determine the appropriate connection type at the present time. AE 106 may predict the expected free time of a customer and the amount of time which may be available and may recommend the connection means and the connection time based on the type of connection means. For example, a phone call may require at least 5 minutes of free time whereas for an SMS it may take only 2 minutes of free time.

AE 106 may determine between various AP, for example AP 102A, 102B, and 102C, and between EAP 120 which one is the optimum AP or EAP. It may also generate a queue from each AP and EAP separately and from the combination of AP and EAP wherein are sorted the different customers based on their availability. It may additionally rank each AP and EAP with respect to each AC and may include use of the weighting factors, optionally automatically generated.

AE 106 may use a customer's profile defined in the engine to find a look alike and may use it as an input in an algorithm which may determine which are most influential. For example, a young technologist is significantly different in “quality” compared to an older non-technologist.

AE 106 may output a list of a queue of customers wherein the customers are sorted by availability, taking into account the weighting factors. It may collect and analyze information from a plurality of DS. It may include a data structure wherein are defined some of the critical fields for availability and the rest of the information for future analysis and research, for example, saving the operating time, customer ID, type of operation and saving it in for quick retrieval based on a time line and according to the customer type. AE 106 may study the information structure from a file, receive a configuration file of the definition of the message structure and translate it into a data structure of availability.

AE 106 may search for similar historical availability patterns and use them to assess current availability. This may include reconstructing the pattern, for example using Signal Recovery/Matrix Completion—Linear Inverse Problems with an algorithm such as Orthogonal Matching Pursuit; addressing the problem as a regression problem and/or using Random Forest or deep neural networks to identify customer availability; using a distance function to identify “similar” past events and derive from them the availability; and translating the availability structure to a STRING, finding STRINGs of availability whose PREFIX is the current STRING; among other known techniques which may be used to search for similar historical availability patterns and use them to assess current availability.

As an example of translating to a STRING, a person who is bored and surfing on CNN news reads 5 articles in 3 minutes. The system may receive an availability event every time he enters an article on CNN news. When asked if the person will be available for another 5 minutes, the system may search the database periodically to extract the entire engagement history with this person (an event row containing a result—answer/not answered, and the duration of the response). During the second minute, the system may take the events of the last 2 minutes and define them as the beginning of time, and may find all the sequences of events that have events similar to the sequence of events that occurred in the other 2 minutes (for example, the sequence of events that includes opening an article every minute). According to these events, the system may assess what was the availability of the person at the 5th minute, and may also determine how many such events are required to support the assessment).

AE 106 may determine the level of boredom/free time of the customer and how much is the customer free compared to other customers. It may identify customers by network activity patterns and may use machine learning (KMEANS, Spectral Clustering, Gaussian Mixture Models GMM), and may combine historical group activity with real-time data using machine learning Bayesian algorithms, and using linear regression algorithms to predict with greater accuracy the availability level of the customer (the amount of activity, the types of operations, and whether there is a higher probability of engagement based on the rest of the data). Other known techniques may be used to determine the level of boredom/free time of the customer and how much is the customer free compared to other customer.

AE 106 may prioritize information received from availability data sources (social networks, RTB, organizational systems, etc.). Sometimes organizational systems may have higher quality information associated with customer availability (e.g. credit card transactions owned by a credit card company), and sometimes external systems may have more quality information (e.g. organization with a site that the customer barely enters). AE 106 may perform automatic prioritization of the DS that are more qualitative and may use machine learning algorithms such as Reinforcement Learning or Online Learning to improve prioritization with each interaction; RNN, DNN (Deep Neural Network), CNN, or Generic Prediction (Random Forest) algorithms to automatically select which data source is of a higher quality for which types of customers. Other known techniques may be used to do the prioritization.

AE 106 may identify patterns of action that are suitable for social networking availability by collecting customer actions from social networks, connecting customers across different social networks, analyzing the information the customer publishes through NLP to understand content, categorizing it, and running machine learning algorithms to predict more accurately the free time of the customer.

EOP 108 may enable the ACs, for example, AC 112, AC 114, and AC 116 to connect its means of communication (e.g. CRM, Autodial, and MMA) to AE 106 and to obtain greater accuracy of availability scheduling. It may allow setting up business rules (for example, to not call customers after 1900 hours and before 800 hours, to not dial the customer more than 3 times a day). EOP 108 may combine availability and business logic, enable optimal identification of a combination between the two, and may build an optimal queue. It may obtain business scoring data from BLS 110 and may receive data from AE 106 to rank customers and mark new “interesting” customers. It may connect to business logic systems that guide customers according to the probability of sale, receives the customer's rating and segmentation, and uses them to determine the optimal queue.

EOP 108 may combine two queues, a queue sorted by availability and a queue sorted by probability of sale. It may identify the optimal combination and the right weights to assign to each of these queues to reach more sales during the working day. EOP 108 may weight between the two queues and, following analysis of the results, may or may not improve the weights it gives to business logic compared to availability. For example, system 100 may rate customers of a type X as those with a highest probability of sale, then those of a type Y, and last those of a type Z with a minimum probability of sale, but in terms of availability, the most available are those customers of type Z, Y after those of Y, and those of X are barely available. The ideal situation for the organization is to contact as many customers as possible with the high probability of sale but that will also answer them, so in the above example it is best to dial customers Y because they are both available and have a high probability of sale. Accordingly, the optimal queue is generated for the respective organizations based on those customers of type Y as the preferential customers.

EOP 108 may make use of neural networks such as recurrent neural networks (RNN), convolutional neural networks (CNN), deep learning, and/or Random Forest prediction algorithm using parameters which may include customer ID parameters, customer type, business data, and availability data. The customer ID's may include, but not be limited to, phone numbers, email addresses, cookie identification, device identification, among others. It may be able to prioritize customer availability over business logic for a limited time, and after that time prioritize business logic over availability. For example, the system may have 4 different campaigns (campaigns 1, 2, 3 & 4), and campaign 2 may be set to be the priority campaign after half an hour. During the first half hour, the system may recommend according to customer availability. After half an hour, all customers in campaign 2 may be selected first, and those in campaigns 1, 3, and 4, may be preferred according to availability after campaign 2.

Customer availability may be weighted inter alia on the basis of the following parameters (not limited to only these parameters and more or less or different parameters may be used depending on the communication means):

a) identity of the website and/or application, and the business category to which they belong;
b) website browsing and/or application usage hours;
c) type of advertising (e.g. video, ad) and/or type of content;
d) customer location;
e) time of day;
f) duration of activity and amount of activity; and
g) time differences between advertising messages displayed to the customer.

EOP 108 may rank bounded groups, that is, no matter how much a customer is available if it is less important. For example, system 100 may have customers from different countries, and assuming that the country of Argentina is the most profitable, then no matter how much a customer from Greece is available, the system may always recommend connecting with the customers from Argentina. EOP 108 may include a matching function that defines customers according to priority areas and allows customers to be ranked within a priority area based on availability, but not to mix the types of priorities. For example, if the weight of availability is between 0 and 1, then a simple adjustment function may be a priority+availability area, where a priority area is a natural number.

AC 112, AC 114, and AC 116 may communicate with the EOP 108 in order to receive for the organization the optimal queue determined by the EOP. They may also transfer customer data for processing by EOP 108 to allow system assessment of the effectiveness of the optimal queue determined and to update system algorithm parameters including AP weights among other system parameters. They may synchronize data with EOP 108 and may include use of push/pull data synching, pulling the current optimal queue which the engagement channel is to execute. They may report the engagement result back to EOP 108 as feedback for continued engagement improvement. For example, AC 114 may query EOP 108 to obtain the current X leads to which it is to dial. AC 112, 114 and 116 may additionally pull from EOP 108 the list of customers with whom a connection is to be made (e.g. for auto dialers, the list may include dialing files or a database, among automatic dialing data sources).

Availability exchange network 118 and availability provider 120 may be used to interface system 100 with data collection and exchange networks which may include availability data sellers, organizational availability providers, availability data buyers, among others, and which may be based on several main sources of data. The data may include social media intelligence (SOCMINT/SMI) data, Real Time Bidding (RTB) data, Enterprise Data Management (EDM) data, and data from external organizations, among others.

Social networks have a lot of information that is known to the general public. The information and events from these networks may be used to analyze customer availability in various networks such as Facebook, Twitter, Telegram, WhatsApp, and Instagram, among others. By analyzing customer actions on these networks, one may identify whether a customer is available or not.

A real-time bid (RTB) for Internet advertisements is a means by which one can purchase and sell advertising space on a display basis through an immediate auction similar to the financial markets. Advertising buyers bid on the advertising space and if a buyer's bid wins, the buyer's ad is instantly displayed on the site visited by the customer. Real-time bidding allows advertisers to manage and optimize ads from multiple ad networks by giving customers access to a large number of different networks, allowing them to create and run campaigns, prioritize networks, and allocate unsold advertising inventory spaces. Nevertheless, there are some problems with using RTB data sources, as described herein below.

RTB customer identification is generally based on cookies which may be deleted every predetermined amount of time, for example, two weeks, by components in the RTB network. When a customer changes cookie, the customer's historical information disappears and there is a need to rebuild the database. The system may solve this problem by identifying network behavior patterns and classifying customers into groups using machine learning (e.g. K-Means, Spectral Clustering, and Gaussian Mixture Models GMM). By associating the customer with the corresponding network activity group the system may also predict customer data based on same group behavior. Customer behavior is generally difficult to change and thereby allows the system to identify the customer even after the cookies have been deleted, inclusive if devices have been switched.

Dealing with a large number of messages at a high rate, and translating actions into “available insights” in real time on the RTB network at any given time may be problematic. Hundreds of thousands of messages are received all the time. The system may solve this problem by operating two mechanisms, an immediate mechanism and a long-term mechanism. The immediate mechanism may be used to handle messages for which immediate availability analysis may be required while the long-term mechanism may handle messages that can be dealt with at a later date. The system may include use of big data systems to store and retrieve the information accordingly.

The information obtained from the RTB network is generally rich and may include many details, for example, type of site, type of operation on the site, location of the customer, among other. In order to extract the availability information from the RTB information, the system may combine several events, may filter the events that are irrelevant/significant to availability, may identify the customer's activity time, and understand whether the event is an in-depth event or a superficial and immediate event. For example, the difference between entering a site and reading a detailed report or viewing an answer to a technical question, or a website is a site regularly visited? Does the location from which the customer enters the site provide an indication of availability? The system may solve this problem by creating a time-based availability structure based on customer events; by tagging events based on predefined activity types, for example, journalism, leisure, business, among others; by using clustering to group customers with similar network behavior and take advantage of customer availability information from the same group to assign availability to one another; by using the time of connection, conversion rate, or other metrics to identify the level of referrals the customer received at the time of the connection; and by creating a historical profile for the customer, by creating a cluster of customers based on historical activity, and by using algorithms tailored to sequential events such as Hidden Markov, CNN, and more.

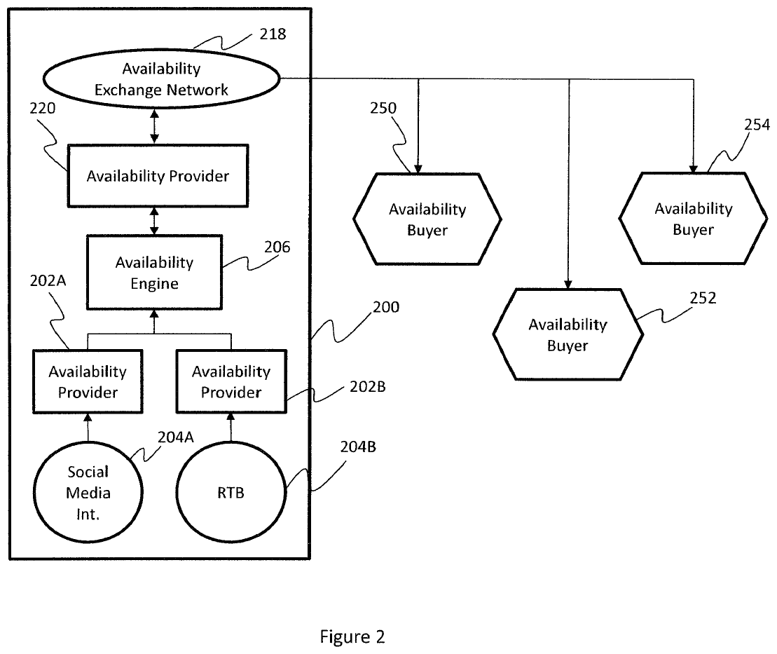

Reference is now made to FIG. 2 which schematically illustrates an exemplary availability ranking system 200 configured to generate optimal queueing information from availability information received from data collection and data exchange networks for sale to availability buyers, according to an embodiment of the present invention. System 200 may include AP 202A and 202B, AE 206, AEN 218 and EAP 220, all of which may be functionally similar to AP 102A and 102B, AE 106, AEN 118 and EAP 120, respectively. The skilled person may readily appreciate that system 200 may additionally include other components functionally similar to those shown in system 100 in FIG. 1 but which have been omitted in the figure for convenience.

System 200 may collect customer information from social media intelligence 204A and from RTB 204B and may process the information to determine customer availability and optimal queuing. The generated information may then be sold to availability buyers, for example, availability buyer 250, 252, and 254, the information supplied through AEN 218 and EAP 220. Optionally, system 200 may allow the data sources to sell availability information associated with their customers through the system while customer privacy is maintained.

Customer information obtained from external organizations such as, for example, application and website operators, may frequently be acquired from dedicated vendors. These vendors, for example, StartAPP, Iron Source, and others, may provide availability information associated with the customers without infringing on the customer' privacy. Other sources of customer information may include credit card companies and cellular companies, among many others.

In some embodiments, the system may allow vendors to sell customers' availability ratings without disclosing content information on the customers. The system may additionally allow an availability consumer to request from a number of available vendors a rating of the customers' availability as if they are customers of the availability consumer. The system may further allow grading all the customers' availability ratings in a ranking order based on each customer's availability.

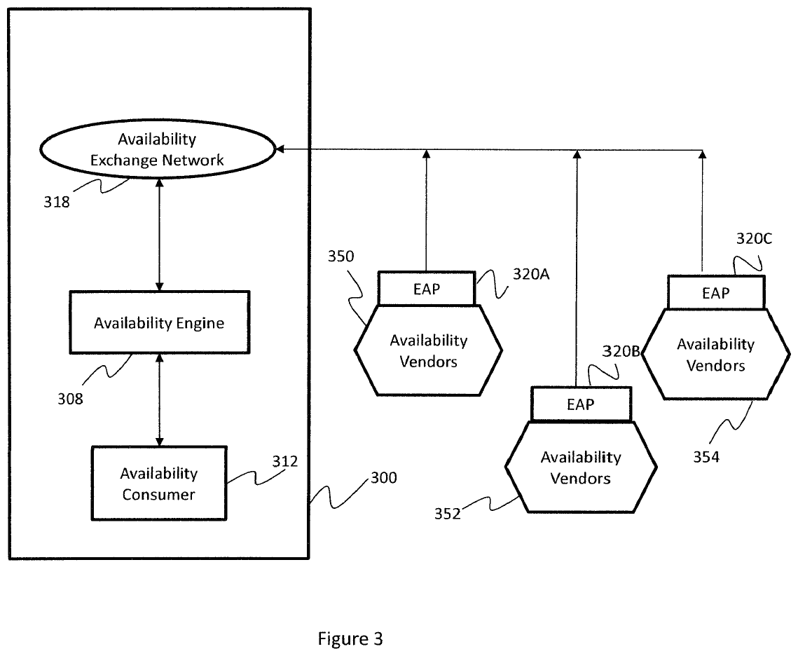

Reference is now made to FIG. 3 which schematically illustrates an exemplary availability ranking system 300 configured to generate optimal queueing information from availability information received from availability sellers for sale to availability buyers, according to an embodiment of the present invention. System 300 may include AC 312, EOP 308, and AEN 318, all of which may be functionally similar to AC 112, EOP 108, and AEN 118, respectively. The skilled person may readily appreciate that system 300 may additionally include other components functionally similar to those shown in system 100 in FIG. 1 but which have been omitted in the figure for convenience.

System 300 may collect customer availability information from availability vendors, for example, availability vendors 350, 352, and 354 and may process the information to determine the optimal queue. The queuing information may then be sold to availability buyers, for example, by transferring the information through AC 312. The availability information may be transferred from availability vendors 350, 352, and 354 by means of their associated EAP 320A, 320B, and 320C, respectively, through AEN 318 to AE 308 who may process the availability data to generate a RL which may be transferred through AC 312 to the availability buyer.

Organizations generally have large amounts of information on customers that stems from their ongoing business activities with the customers. These may include customer identification data associated with phone numbers, emails, Cookie identifications, advertising identification; call logs and previous calls with the customer; calendar of previous emails and contacts with the customer; how and when web sites are used; how and when apps are used; and customer characteristics such as age, sex, city of residence, profession, among others. Additionally, it may be possible to receive information about events in real time from systems in the organization and attach them to the customer information. This may include real-time information associated opening an email, logging on, chatting with the organization's chat, and more.

In some embodiments, the system may include a number of generic components suitable for each organization (e.g. Web Pixel AP, Email Pixel AP, Auto Dialer AP and CRM AP). The organizations may expand the system with plugins that connect to other systems in the organization (e.g. a credit card company can produce an extension that analyzes customer credit card transactions and provides availability information associated with the transactions).

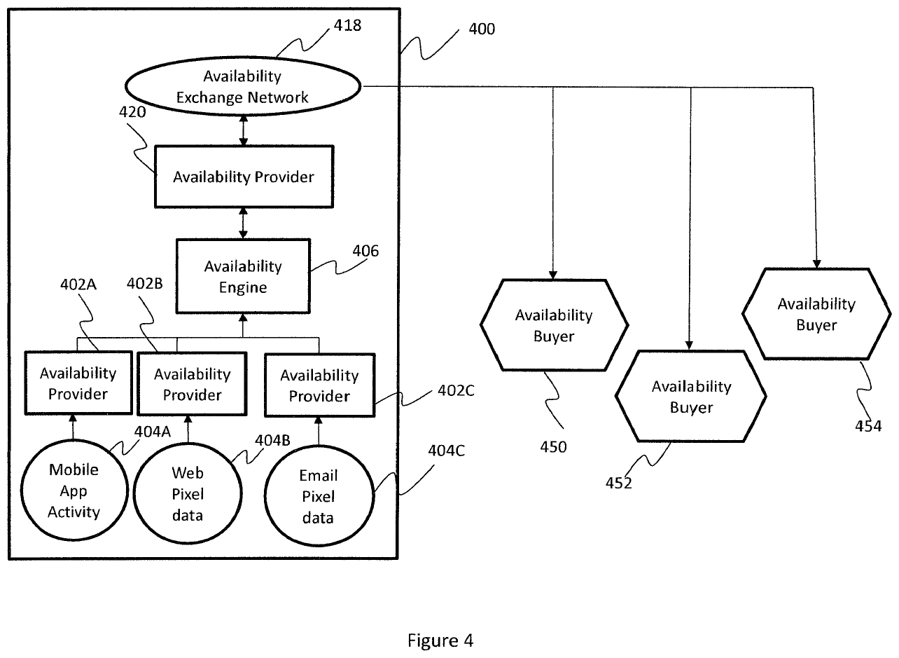

Reference is now made to FIG. 4 which schematically illustrates an exemplary availability ranking system 400 configured to generate optimal queueing information from availability information received from organizations for sale to availability buyers, according to an embodiment of the present invention. . System 400 may include AP 402A, AP 402B, AP 402C, AE 406, AEN 418, and EAP 420, all of which may be functionally similar to AP 102A and 102B, AP 102C, AE 106, AEN 118, and EAP 120, respectively. The skilled person may readily appreciate that system 400 may additionally include other components functionally similar to those shown in system 100 in FIG. 1 but which have been omitted in the figure for convenience.

System 400 may collect customer information from organizations, for example, from organizational mobile phone application activity 404A, from Web pixel data 404B, and from email pixel data 404C, and may process the information to determine customer availability and optimal queuing. The generated information may then be sold to availability buyers, for example, availability buyer 450, 452, and 454, the information supplied from AE 406 through EAP 420 and AEN 218. Optionally, system 400 may allow the organizations to sell availability information associated with their customers through the system while maintaining customer privacy.

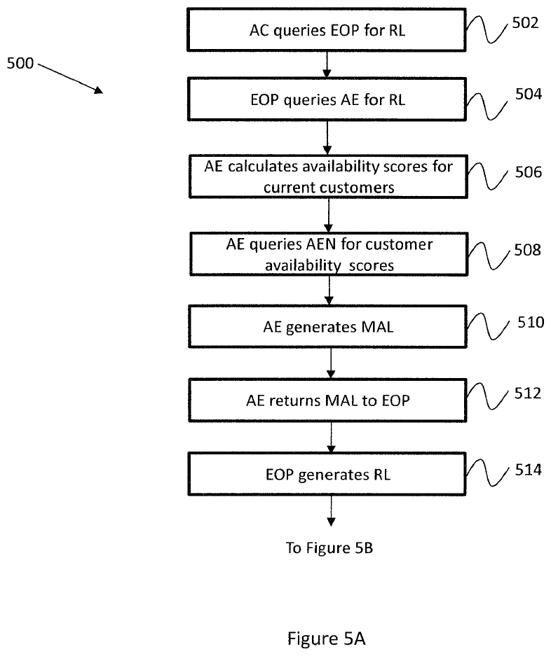

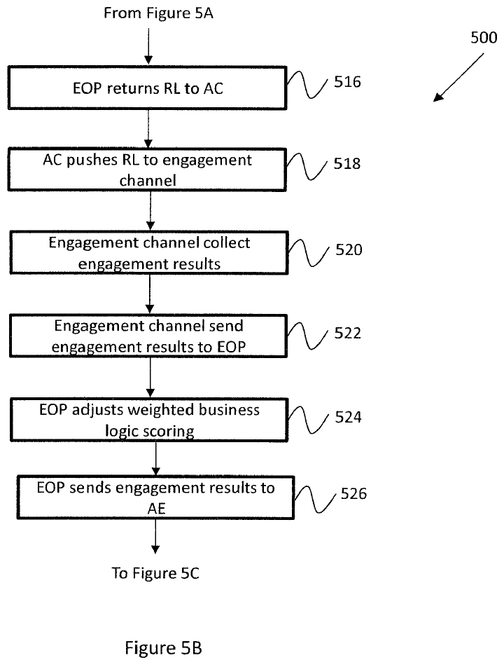

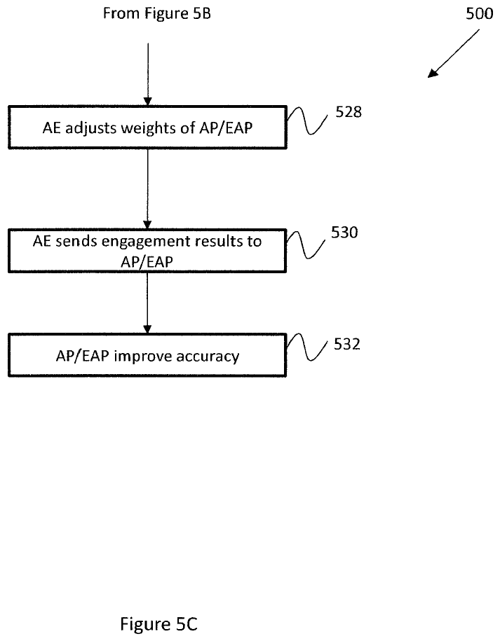

Reference is now made to FIGS. 5A, 5B and 5C which is a flow chart of an exemplary method 500 of using the availability ranking system in a customer engagement, according to an embodiment of the present invention Method 500 is described with reference to a system user, in this case an organization, interested in obtaining an optimal queueing list for contacting customers. For exemplary and clarity purposes, the method is described with reference to system 100 shown in FIG. 1. Nevertheless, it may be appreciated that the method described is not limited only to this application and may be used in numerous other applications, for example, as described with systems 200, 300 and 400, respectively shown in FIGS. 2, 3 and 4. The skilled person may realize that the method may be implemented using more or less steps and/or a different sequence of steps.

At 502, an AC, for example AC 112, may query EOP 108 for the RL.

At 504, the EOP 108 may query AE 106 for the merged availability list (MAL).

At 506, AE 106 may calculate the availability score for all the current customers based on user availability events which may be stored in a local database in a local availability list (LAL).

At 508, AE 106 may query AEP 120 through AEN 118 for scores associated with the relevant customers. The query may be made using a customer identification number or other means without disclosing the customer's name or other personal details. The customer scores may be held in an external availability list (EAL).

At 510 AE 106 may merge the LAL with the EAL to generate a MAL.

At 512, AE 106 may send the MAL to EOP 108.

At 514, EOP 108 may merge the business score from BSL 110 into the MAL and may generate the RL.

At 516, EOP 108 may return the updated RL to AC 112.

At 518, AC 112 may push the RL into an engagement channel (not shown) to engage with the customers.

At 520, the engagement channel may engage with the customers in the order they appear in the RL and may collect the engagement results.

At 522, the engagement channel may send the engagement results to EOP 108.

At 524, EOP 108 may adjust the weight of the business scoring vs. the availability scoring for future use. The adjusted business weight may be stored in BLS 110.

At 526, EOP 108 may send the engagement results to AE 106.

At 528, AE 106 may adjust the weight of AP 102A-102C and EAP 120.

At 530, AE 106 may send the engagement results to AP 102A-102C and EAP 120.

At 532, AP 102A-102C and EAP 120 may use the engagement results for accuracy improvement.

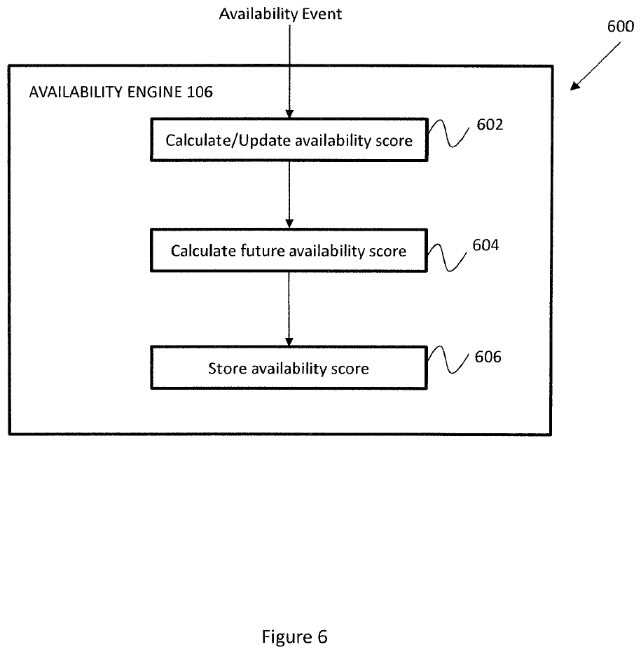

Reference is now made to FIG. 6 which is a flow chart of a method 600 of how the AE may analyze availability responsive to receiving an availability event, according to an embodiment of the present invention. For exemplary and clarity purposes, the method is described with reference to system 100 shown in FIG. 1. Nevertheless, it may be appreciated that the method described is not limited only to this application and may be used in numerous other applications, for example, as described with systems 200, 300 and 400, respectively shown in FIGS. 2, 3 and 4. The skilled person may realize that the method may be implemented using more or less steps and/or a different sequence of steps.

At 602, AE 106 may receive an availability event associated with a customer and may calculate/update an availability score for the customer.

At 604, AE 106 may determine, based on the type of event, to calculate/update the customer's score for future use.

At 606, AE 106 may store the calculated/updated for a relatively short time, or alternatively for a relatively long time for future use.

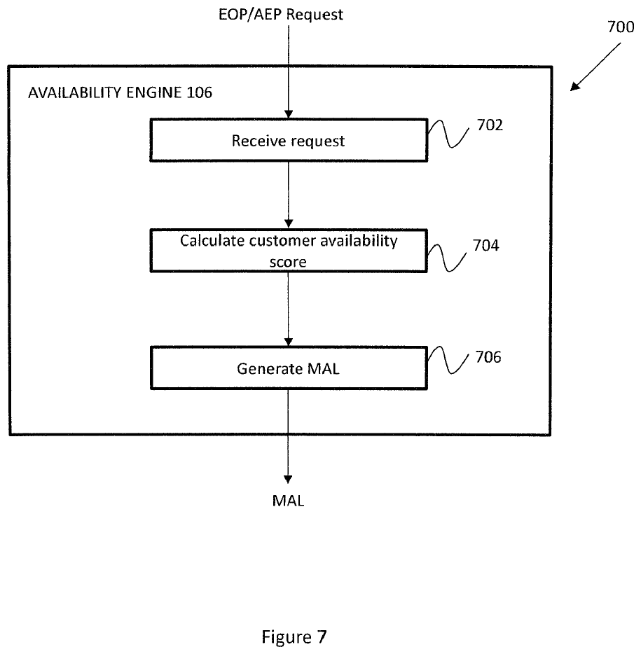

Reference is now made to FIG. 7 which is a flow chart of a method 700 of how the AE may analyze availability responsive to receiving a request for the MAL from EOP 108 or from AEP 120, according to an embodiment of the present invention. For exemplary and clarity purposes, the method is described with reference to system 100 shown in FIG. 1. Nevertheless, it may be appreciated that the method described is not limited only to this application and may be used in numerous other applications, for example, as described with systems 200, 300 and 400, respectively shown in FIGS. 2, 3 and 4. The skilled person may realize that the method may be implemented using more or less steps and/or a different sequence of steps.

At 702, AE 106 may receive the request.

At 704, AE 106 may calculate the customer availability score. The customer availability score may include the scores generated from the data received from AP 102A-102C and the availability score received from AEP 120.

At 706, AE 106 may generate the MAL.

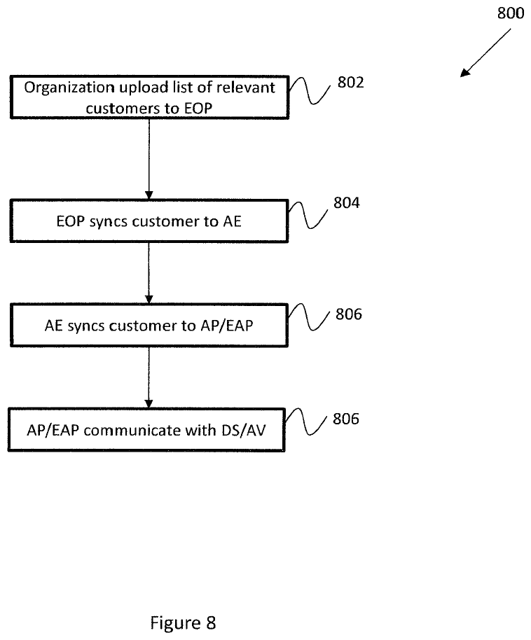

Reference is now made to FIG. 8 which is a flow chart of a method 800 of how customers may be synched in a ranking system, according to an embodiment of the present invention. For exemplary and clarity purposes, the method is described with reference to system 100 shown in FIG. 1. Nevertheless, it may be appreciated that the method described is not limited only to this application and may be used in numerous other applications, for example, as described with systems 200, 300 and 400, respectively shown in FIGS. 2, 3 and 4. The skilled person may realize that the method may be implemented using more or less steps and/or a different sequence of steps.

At 802, the organization, through integration, may upload to EOP 108 the list of relevant customers for ranking

At 804, EOP 108 may synch the customers to AE 106.

At 806, AE 106 may synch the customers IDs to AP 102A-102C and/or AEP 120.

At 808, AP 102A-102C may communicate with DS 104A-104C to receive data about the customer IDs and and/or AEP 120 to AV.

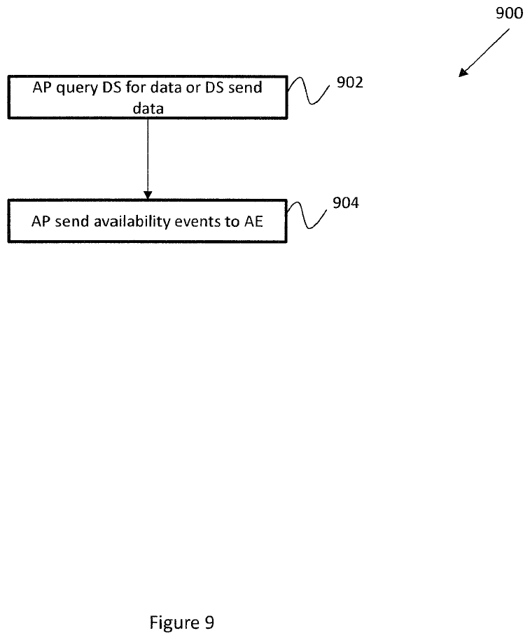

Reference is now made to FIG. 9 which is a flow chart of a method 900 of how data from data sources is received in the ranking system, according to an embodiment of the present invention. For exemplary and clarity purposes, the method is described with reference to system 100 shown in FIG. 1. Nevertheless, it may be appreciated that the method described is not limited only to this application and may be used in numerous other applications, for example, as described with systems 200, 300 and 400, respectively shown in FIGS. 2, 3 and 4. The skilled person may realize that the method may be implemented using more or less steps and/or a different sequence of steps.

At 902, AP 102A-102C may query DS 104A-104C for customer data at predetermined intervals and/or the DS may send the customer data every time availability event-related data is detected or at predetermined intervals.

At 904, AP 102A-102C send the availability event to AE 106.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a general purpose computer of any type such as a client/server system, mobile computing devices, smart appliances or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, or it may comprise a general-purpose computer selectively activated or reconfigured by a computer program stored in the computer. The resultant apparatus when instructed by software may turn the general purpose computer into inventive elements as discussed herein. The instructions may define the inventive device in operation with the computer platform for which it is desired. Such a computer program may be stored in a computer readable storage medium, such as, but not limited to, any type of disk, including optical disks, magnetic-optical disks, read-only memories (ROMs), volatile and non-volatile memories, random access memories (RAMs), electrically programmable read-only memories (EPROMs), electrically erasable and programmable read only memories (EEPROMs), magnetic or optical cards, Flash memory, disk-on-key or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method of optimizing a customer engagement, the method comprising:
a. communicating with a plurality of data providers to acquire information associated with each customer's computer-trackable use of one or more computing devices;
b. for each customer,
acquiring data associated with availability events in said information;
processing said acquired data including applying a weighting factor during said processing; and
calculating a weighted availability score for the customer;
c. generating an availability list comprising the weighted availability score of each customer;
d. combining a weighted business logic score for each customer with said customer weighted availability score in said availability list;
e. generating a ranking list wherein said plurality of customers are ranked by the combined business logic score and weighted availability score of each customer;
f. transferring said ranking list to a customer engagement system for engaging with each customer according to their ranking order on said ranking list; and
g. acquiring from said customer engagement system engagement data associated with said engaging for each customer in said plurality of customers.

2. A method according to claim 1 further comprising:
h. adjusting said weighted business logic score for at least a portion of said customers based on said engagement data; and
i. adjusting said weighting factor applied during said processing.

3. A method according to claim 1 further comprising sending said engagement data to said plurality of data providers.

4. A method according to claim 1 wherein said processing comprises generating availability event structures.

5. A method according to claim 4 comprising generating an availability score from said availability event structure.

6. A method according to claim 1 wherein said acquired data comprises an availability score.

7. (canceled)

8. (canceled)

9. (canceled)

10. (canceled)

11. A method according to claim 1 further comprising acquiring said information from a real-time bidding (RTB) network.

12. A method according to claim 11 comprising extracting availability information from said RTB network information by performing any combination of the following tasks:
combining a plurality of events;
filtering said plurality of events into availability significant and insignificant events;
identifying the customer's activity time; and
analyzing whether each event is superficial and immediate, or an in-depth event.

13. A method according to claim 12 further comprising creating a time-based availability structure based on said plurality of events.

14. A method according to claim 12 further comprising tagging events based on a predefined activity type.

15. (canceled)

16. (canceled)

17. (canceled)

18. (canceled)

19. (canceled)

20. (canceled)

21. (canceled)

22. A system for optimizing a customer engagement, comprising:
a database;
communication means to communicate with a plurality of data providers to acquire information associated with each customer's computer-trackable use of one or more computing devices; and
a processor configured to, for each customer:
a. acquire data associated with availability events in said information;
b. process said acquired data including applying a weighting factor during said processing;
c. calculate a weighted availability score for the customer;
d. generate an availability list comprising the weighted availability score of each customer;
e. combine a weighted business logic score for each customer with said customer weighted availability score in said availability list;
f. generate a ranking list wherein said plurality of customers are ranked by the combined business logic score and weighted availability score of each customer;
g. transfer said ranking list to a customer engagement system for engaging with each customer according to their ranking order on said ranking list; and
h. acquire from said customer engagement system engagement data associated with said engaging for each customer in said plurality of customers.

23. A system according to claim 22 wherein said processor is further configured to:
i. adjust said weighted business logic score for at least a portion of said customers based on said engagement data; and
j. adjust said weighting factor applied during said processing.

24. A system according to claim 22 wherein said processor is further configured to send said engagement data to said plurality of data providers.

25. A system according to claim 22 wherein said processing comprises generating availability event structures.

26. A system according to claim 25 wherein said processor generates an availability score from said availability event structure.

27. A system according to claim 22 said acquired data comprises an availability score.

28. (canceled)

29. (canceled)

30. (canceled)

31. (canceled)

32. A system according to claim 22 wherein said communication means acquires said information from a real-time bidding (RTB) network.

33. A system according to claim 32 wherein said processor acquires availability information from said RTB network information by performing any combination of the following tasks:
combining a plurality of events;
filtering said plurality of events into availability significant and insignificant events;
identifying the customer's activity time; and
analyzing whether each event is superficial and immediate, or an in-depth event.

34. A system according to claim 33 wherein said processor creates a time-based availability structure based on said plurality of events.

35. A system according to claim 33 wherein said processor tags events based on a predefined activity type.

36. (canceled)

37. (canceled)

38. (canceled)

39. (canceled)

40. (canceled)

41. (canceled)

42. (canceled)
